(19) United States
(12) Patent Application Publication
(10) Pub. No.: US 2009/0225074 A1
(43) Pub. Date: Sep. 10, 2009

(54) Reconstruction of Virtual Environments Using Cached Data

(76) Inventors: Cary L. Bates, Rochester, MN (US); Jim C. Chen, Rochester, MN (US); Zachary A. Garbow, Rochester, MN (US); Gregory E. Young, South St. Paul, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/043,427

(22) Filed: Mar. 6, 2008

(51) Int. Cl. G06T 15/00

(52) U.S. Cl. 345/419

(57) ABSTRACT

Embodiments of the invention provide a method of reconstructing a virtual world environment by retrieving data from multiple users present in the environment at a given point in time. Each user may maintain scene data describing the virtual environment at different points in time. The scene data describes one or more elements present in the scene, from the perspective of an avatar associated a given user. To reconstruct a scene, the scene data from multiple caches may be shared over a peer-to-peer type network.

### BACKGROUND OF THE INVENTION

Embodiments of the invention generally relate to virtual environments, and more specifically, to the reconstruction of virtual environments the reconstruction of virtual environments using cached data from multiple users.

### DESCRIPTION OF THE RELATED ART

A virtual world is a simulated environment which users may inhabit and interact with one another via avatars. An avatar generally provides a graphical representation of an individual within the virtual world environment. Avatars are usually presented to other users as graphical representation of human characters. Multiple users “enter” a virtual world by logging on to a central server(s), and interact with one another through the actions of their avatars. The actions of a given avatar are controlled by the corresponding individual typically using a mouse and keyboard. Virtual worlds provide an immersive environment with an appearance typically similar to that of the real world, with real world rules such as gravity, topography, locomotion, real-time actions, and communication. Communication may be in the form of text messages sent between avatars, but may also include real-time voice communication.

Virtual worlds may be persistent between times when a given user is logged on. A persistent world provides an immersive environment (e.g., a fantasy setting used as a setting for a role-playing game) that is generally always available, and virtual world events happen continually, regardless of the presence of a given avatar. Thus, unlike more conventional online games or multi-user environments, the events within a virtual world continue to occur for connected users even while they are not actively logged on to the virtual world.

### SUMMARY OF THE INVENTION

One embodiment of the invention includes a method of capturing scene data from a scene in an interactive virtual environment. The method may generally include determining a viewport associated with a first avatar based on a position of the first avatar in the interactive virtual environment at a specified time-point. The viewport includes a set of elements in the scene visible to the first avatar at the specified time-point. The method may further include selecting one or more elements from the set of elements of the virtual world visible in the viewport, determining element location coordinates that specify a position of each selected virtual world element in the interactive virtual environment, and generating, for each selected element, a description that includes at least the element location coordinates for a respective element. The method may further include storing the generated descriptions in a first cache and associating the first cache with the first avatar. The descriptions of the scene are accessible for reconstructing the scene by a user associated with a second avatar over a peer-to-peer network.

Another embodiment of the invention includes a computer-readable storage medium containing a program that when executed, performs an operation for capturing scene data from a scene in an interactive virtual environment. The operation may generally include determining a viewport associated with a first avatar based on a position of the first avatar in the interactive virtual environment at a specified time-point. The viewport includes a set of elements in the scene visible to the first avatar at the specified time-point. The operation may further include selecting one or more elements from the set of elements of the virtual world visible in the viewport, determining element location coordinates that specify a position of each selected virtual world element in the interactive virtual environment, and generating, for each selected element, a description that includes at least the element location coordinates for a respective element. The operation may further include storing the generated descriptions in a first cache and associating the first cache with the first avatar. The descriptions of the scene are accessible for reconstructing the scene by a user associated with a second avatar over a peer-to-peer network.

Still another embodiment includes a system comprising a processor and a memory containing a containing a program that, when executed by the processor, performs an operation for capturing scene data from a scene in an interactive virtual environment. The operation may generally include determining a viewport associated with a first avatar based on a position of the first avatar in the interactive virtual environment at a specified time-point. The viewport includes a set of elements in the scene visible to the first avatar at the specified time-point. The operation may further include selecting one or more elements from the set of elements of the virtual world visible in the viewport, determining element location coordinates that specify a position of each selected virtual world element in the interactive virtual environment, and generating, for each selected element, a description that includes at least the element location coordinates for a respective element. The operation may still further include storing the generated descriptions in a first cache and associating the first cache with the first avatar. The descriptions of the scene are accessible for reconstructing the scene by a user associated with a second avatar over a peer-to-peer network.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a networked system 100 for peer-to-peer virtual environment reconstruction, according to one embodiment of the invention.

FIG. 2 illustrates an example virtual scene with multiple users present at one point in time, according to one embodiment of the invention.

FIG. 3 illustrates an example virtual scene with multiple users present over an interval of time, according to one embodiment of the invention.

FIG. 4 illustrates an example element table, according to one embodiment of the invention.

FIG. 5 illustrates an example avatar location table, according to one embodiment of the invention.

FIG. 6 illustrates a method for caching data in a virtual environment, according to one embodiment of the invention.

FIG. 7 illustrates a method for reconstructing a virtual scene from multiple viewpoints, according to one embodiment of the invention.

### DETAILED DESCRIPTION OF THE PREFERRED EMBODIMENTS

Embodiments of the invention provide a method of reconstructing a virtual world environment by retrieving data from multiple users present in the environment at a given point in time. Each user may maintain scene data describing the virtual environment at different points in time. The scene data describes one or more elements present in the scene from a perspective of an avatar associated with a given user. To reconstruct a scene, the scene data from multiple caches may be shared over a peer-to-peer type network.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

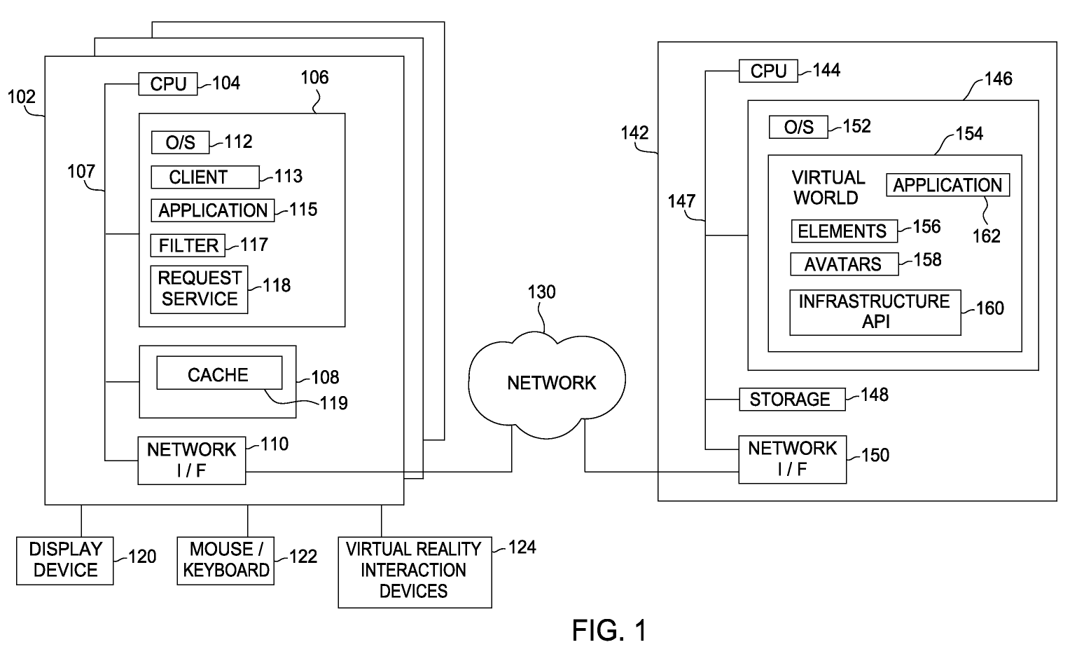

FIG. 1 is a block diagram illustrating a networked system 100 for peer-to-peer virtual environment reconstruction, according to one embodiment of the invention. As shown, the networked system 100 includes multiple client computers 102, and a virtual world server 142. The client computers 102 and server 142 are connected via a network 130. In general, the network 130 may be any data communications network (e.g., a TCP/IP network such as the Internet) configured to support a peer-to-peer networking application. Illustratively, client computer 102 includes a Central Processing Unit (CPU) 104, a memory 106, a storage 108, and a network interface device 110, coupled to one another by a bus 107. The CPU 104 could be any processor used to perform an embodiment of the invention.

The memory 106 may be a random access memory sufficiently large to hold the necessary programming and data structures that are located on the client computer 102. The programming and data structures may be accessed and executed by the CPU 104 as needed during operation. While the memory 106 is shown as a single entity, it should be understood that the memory 106 may in fact comprise a plurality of modules, and that the memory 106 may exist at multiple levels, from high speed registers and caches to lower speed but larger DRAM chips.

Storage 108 represents any combination of fixed and/or removable storage devices, such as fixed disc drives, floppy disc drives, tape drives, removable memory cards, flash memory storage, or optical storage. The memory 106 and storage 108 could be part of one virtual address space spanning multiple primary and secondary storage devices. As shown, the storage 108 includes a cache 119. The cache 119 may provide a set of data structures such as tab-separated flat files or database management system (DBMS) tables that contains data captured about elements 156 and avatars 158 encountered during the user's virtual world experience. Further embodiments of the cache 119 are described below in the description of the capture application 115.

The network interface device 110 may allow network communications between the client computer 102, the administrator 132, and the virtual world server 162 via the network 190. For example, the network interface device 110 may be a network adapter or other network interface card (NIC). As shown, the memory 106 includes an operating system 112, a client application 113, a capture application 115, a filter 117, and a request service 118. The request service 118 may be software that sends/receives data requests between two or more client computers 102, as part of a peer-to-peer network.

The client computer 102 is under the control of an operating system 112, shown in the memory 106. Examples of operating systems 112 include UNIX, versions of the Microsoft Windows® operating system, and distributions of the Linux® operating system. (Note: Linux is at trademark of Linus Torvalds in the United States and other countries.) More generally, any operating system 112 supporting the functions disclosed herein may be used.

In one embodiment, the client application 113 provides a software program that allows a user to connect to a virtual world 154, and once connected, to explore and interact with the virtual world 154. Further, application 113 may be configured to generate and display an avatar representing the first user as well as avatars 158 representing other users. That is, the avatars 158 may provide a visual representation of their respective users within the virtual world 154.

The avatar representing a given user is generally visible to other users in the virtual world and that user may view avatars 158 representing the other users. In one embodiment, the client application 113 may be configured to transmit the user's desired actions to the virtual world 154 on the server 142. The client application 113 may be further configured to generate and present the user with a display of the virtual world 154. Such a display generally includes content, referred to herein as elements 156, from the virtual world 154 determined from the line of sight of a camera position at any given time. For example, the user may be presented the virtual world 154 through the “eyes” of the avatar, or alternatively, with a camera placed behind and over the shoulder of the avatar.

While a user navigates their corresponding avatar 158 through the virtual world 154, the capture application 115 may, over regularly timed intervals, capture data about the particular elements 156 in the avatar's viewpoint. Further, at each interval (also referred to herein as a time-point), the capture application 115 may store the data within the cache 119. In some embodiments, the capture application 115 may store data about the user's avatar's actions and location coordinates, in the cache 119. In one embodiment, data stored in the cache 119 may be requested by other users navigating the virtual world 154. As used herein, the term viewport generally refers to the set of elements 156 of the virtual world 154 visible to the avatar at any given time-point.

In some embodiments, each user may reserve an amount of storage, e.g., 256 MB, for the cache 119 used to capture data about the virtual world 154. According to one embodiment, the amount of data cached can be configured by each user based on the user's personal preferences, available resources, and/or the impact that the storage allocation has on the client's performance.

Because the amount of storage available for the cache 119 is limited, the filter 117 may optimize cache 119 usage by filtering some elements 156 in the viewport, such that the capture application does not store the filtered elements in the cache 119. For example, when caching visible elements which provide a virtual representation of an outdoor park, the cache 119 may not store data regarding each tree, rock, and or blade of grass included in the display of the virtual park.

In one embodiment, elements 156 in the viewport may be filtered through a prioritization scheme. In such a case, the filter 117 may dynamically prioritize elements in the viewport according to set criteria, then filter out elements 156 by priority beyond a set limit on the number of elements to be cached at any one time-point. For example, at a particular time-point, the avatar 158 may have ten elements 156 within the viewport. If the capture application 115 only caches five elements at each time-point, the filter 117 may prioritize the ten elements based on the elements' sizes. Accordingly, the capture application caches the five largest elements, and the remaining five are filtered out. The filter 117 may further, or alternately, prioritize elements 156 based on the elements' type, or movements (or lack thereof).

Further embodiments may alternately employ a filtering criteria as opposed to a prioritization scheme. In such a case, the filter 117 may filter out elements 156 of a certain type, e.g. background elements. For example, an avatar 158 may be exploring a virtual park. Rather than use cache space capturing every landscape feature such as trees, grass, and rocks, the capture application 115 may dedicate cache space to foreground elements such as other avatars 158, bikes, skateboards, baseball, and soccer fields.

Those skilled in the art recognize that many potential criteria may be used to prioritize and/or filter elements 156 from the cache, and the prioritization and filtering criteria discussed above are merely provided as examples, and are not meant to be an exhaustive list of potential embodiments of the filter 117.

In one embodiment, the capture application 115 may further optimize cache space usage by limiting the amount of detail cached for each element 156 stored in the cache 119. For example, the capture application 115 may store an amount of detail for elements 156 in correlation with the amount of space available in the cache 119.

The user may view the virtual world 154 using a display device 120, such as an LCD or CRT monitor display, and interact with the client application using a mouse and keyboard 122. Further, in one embodiment, the user may interact with the application 113 and virtual world 154 using a variety of virtual reality interaction devices 124. For example, the user may don a set of virtual reality goggles that have a screen display for each lens. Further, the goggles could be equipped with motion sensors that cause the view of the virtual world 154 presented to the user to move based on the head movements of the individual. As another example, the user could don a pair of gloves configured to translate motion and movement of the user's hands into avatar movements within the virtual world 154 environment. Of course, embodiments of the invention are not limited to these examples and one of ordinary skill in the art will readily recognize that the invention may be adapted for use with a variety of devices configured to present the virtual world 154 to the user and to translate movement/motion or other actions of the user into actions performed by the avatar representing that user within virtual world 146.

As shown, the virtual world server 142 includes a CPU 144, a memory 146 storing an operating system 152, storage 148, and network interface 150. Illustratively, memory 146 includes virtual world 154. As stated, virtual world 154 may be a software application that allows users to explore and interact with the immersive environment provided by virtual world 154. The virtual world 154 may define a virtual “space” representing, for example, a street, a room, a town, a building with multiple floors, a forest, or any other configuration of a virtual space. Illustratively, virtual world 154 includes elements 156, and avatars 158.

The set of elements 156 and avatars 158 present at any given point in time in virtual world 154 define a virtual environment for the location being currently occupied by the user's avatar. In an example of a virtual environment such as a virtual shopping center, the elements 156 may include the walls, aisles, floors and ceilings of the virtual store interior, and the items for sale in the store. The avatars 158 may include avatars representing sales clerks, managers and other shoppers. “Behind” each avatar may be another user, but some avatars may be controlled by computer programs. For example, an avatar representing the manager may correspond to a user operating the virtual store, where an avatar representing an admission clerk at a virtual theater might be controlled by the appropriate software application. The elements for sale may include elements of the virtual world (e.g., virtual clothing that a user may purchase for their avatar), and may also include a shopping environment that allows the user to purchase real-world goods or services.

The reconstruct application 162 may reconstruct a previously visited location at a particular time-point from multiple viewpoints. According to one embodiment, the reconstructed environment may be interactive. For example, after leaving a virtual store, the user may wish to go back to the store to re-examine an item, e.g., a jacket for sale. Because the item may no longer be available (the jacket may have sold since the user left the store), the user may request a reconstruction based on a set of user-specified location and time coordinates.

According to one embodiment, embodiments may incorporate a ‘slide bar’ tool whereby the user may ‘rewind’ the ongoing virtual world experience to a point in time that the user desires to see reconstructed. In such a case, a slide bar may appear as a horizontal scroll bar at the bottom of the user's screen, wherein a placeholder (such as a block on a scroll bar), represents the current point in time, and the entire slide bar represents the range of time over which the user has been exploring the virtual world 154. In such an embodiment, the user may click on the placeholder and move the placeholder ‘back’ to the point in time that the user wants reconstructed. Based on the time requested, the reconstruct application 162 may calculate the user's avatar's location coordinates at that time-point.

Based on the data stored in the caches 119 of the multiple users whose avatars 158 were present at the requested time, the reconstruct application 162 may render elements 156 and avatars 158 as they were at the location and time coordinates specified by the requesting user. Because the environment is reconstructed from the perspective of multiple users, the user may re-view and navigate the environment from multiple perspectives, such as that of other virtual shoppers or the perspective of the virtual manager. That is, even though originally displayed through a single camera position, the reconstruction may allow the user to move the camera and view elements of the virtual world that were present, but not visible at the time the events depicted in the reconstruction originally occurred.

According to one embodiment, in response to a user request, the reconstruct application 162 may determine what other avatars were present at the requested location coordinates and time-point. The reconstruct application 162 may then gather the data recorded in the caches 119 of all the users whose avatars were present at the location and time coordinates specified by the requesting user.

In one embodiment, the reconstruct application 162 may query the virtual world infrastructure API 160 to determine which avatars 158 were present, and gather the data from the caches 119 of the avatars' respective users over a peer-to-peer connection. In such a case, the request service 118 on the requesting user's client computer 102 may send requests for the cache data required for the virtual environment reconstruction. Accordingly, the request services 118 on the other present users' clients may receive the requests, and send the requested cache data to the requesting user's client 102. No single user can cache all data in the virtual environment, so the amount and detail of data cached by each user is variable, thus the need for a peer-to-peer retrieval.

According to one embodiment, the user may also specify a level of detail for the reconstruction. For example, the level of detail may indicate a level of granularity for images depending on the user's desires. In some cases, the user may want high granularity to see as much detail as possible. In other cases, the user may only desire a low granularity, possibly only the outlines of images. Advantageously, by allowing the capture application 115 to vary the level of detail captured, the reconstruct application 162 may reconstruct a scene more quickly where only a low level of detail is requested. Embodiments of the invention may interpret a level of detail specification differently. In some cases, the level of detail may indicate a percentage whereby only the specified percentage of elements 156 originally captured at a particular time-point are to be rendered in the reconstruction. Those skilled in the art recognize that the level of detail may be implemented in a variety of ways to manage resources such as the cache 119 and CPUs 104, 144 according to user-specific requirements. Accordingly, embodiments that incorporate a user-specified level of detail are not limited to the examples provided herein.

Additionally, FIG. 1 illustrates one possible hardware/software configuration for the networked clients 102, and virtual world server 142. Embodiments of the present invention can apply to any comparable hardware configuration, regardless of whether the computer systems are complicated, multi-user computing apparatus, single-user workstations or network appliances that do not have non-volatile storage of their own. The various components of the embodiments of the invention need not be distributed as shown in FIG. 1; rather, all the components may reside on the same machine.

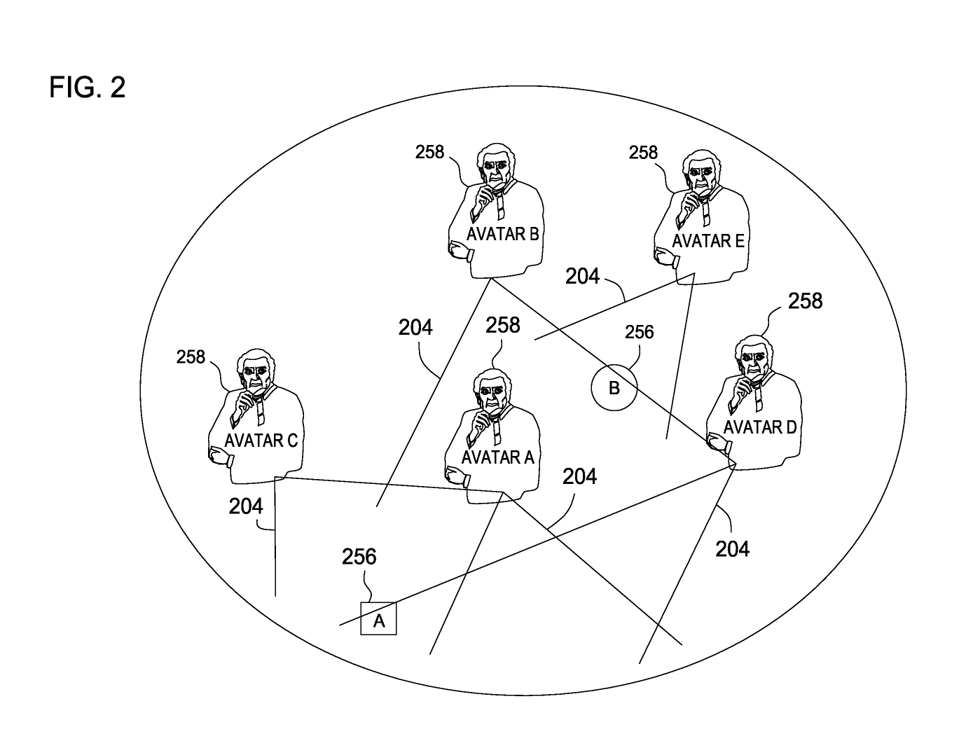

FIG. 2 illustrates an example virtual scene 200 at a location time-point with multiple users present, according to one embodiment of the invention. Virtual scene 200 includes avatars A-E 258, the respective viewports 204 of avatars A-E, and elements A and B 256. In some embodiments, the capture application 115 may store the coordinates of each avatar's viewport for each time-point during the user's virtual world exploration. As shown, there are no elements in avatar A's viewport 204. However, if the user for avatar A were to return to scene 200 at this time-point, the reconstruct application 162 may render the scene as shown. Accordingly, upon re-visiting this location time-point, the user of avatar A could explore the reconstructed scene 200 beyond avatar A's original viewport, viewing elements 156 and avatars 158 not previously seen, such as elements A and B 256, and avatars B-E 258.

For example, in a reconstructed scene in the virtual store described in FIG. 1, the user may view items seen by other shoppers, such as a pair of jeans in another avatar's shopping cart. Because the reconstructed shopping scene may be interactive, the user may pick up and inspect the pair of jeans from another shopper's cart.

According to one embodiment, the reconstruct application 162 may merge details from multiple user caches 119 into a rendering of any one element 156. However, the visible details of elements 156 rendered in a reconstructed scene may be limited by the amount of data stored in the user caches 119 used in the reconstruction. For example, the size of a particular cache 119 may narrow the level of available detail on a particular element. Further, a user that was present at a scene to be reconstructed may log off before the reconstruction, depriving the reconstruction of the details captured in that user's cache. Accordingly, in some cases, the reconstruct application 162 may render a blank visual space for missing details of elements 156, entire elements 156, or even avatars 158.

For example, were the user with the jeans in the virtual shopping cart not available during a reconstruction of the store scene, the cache 119 containing details of the view of the jeans may not be available. However, if the requesting user (or any other user whose avatar was present) saw the front of the jeans, the detail of the front of the jeans may be available and rendered in the reconstruction. Further, if the reconstruction requesting user were to pick up the jeans for examination, the user may see a blank space when inspecting the back of the jeans because only the user whose avatar viewed the back of the jeans may provide the cache data about the detail of the back of the jeans for the reconstruction.

According to one embodiment, the infrastructure API 160 may provide details that help complete the rendering of known elements 156 in the virtual world. For example, in the virtual world described above, all jeans may have universal characteristics. Accordingly, the reconstruct application 162 may query the infrastructure API 160 for details about what the back of jeans look like in the virtual world 154. In turn, instead of a blank space, the reconstruct application 162, may render the view of the back of the jeans even though the user that saw the jeans is not available to provide the detail.

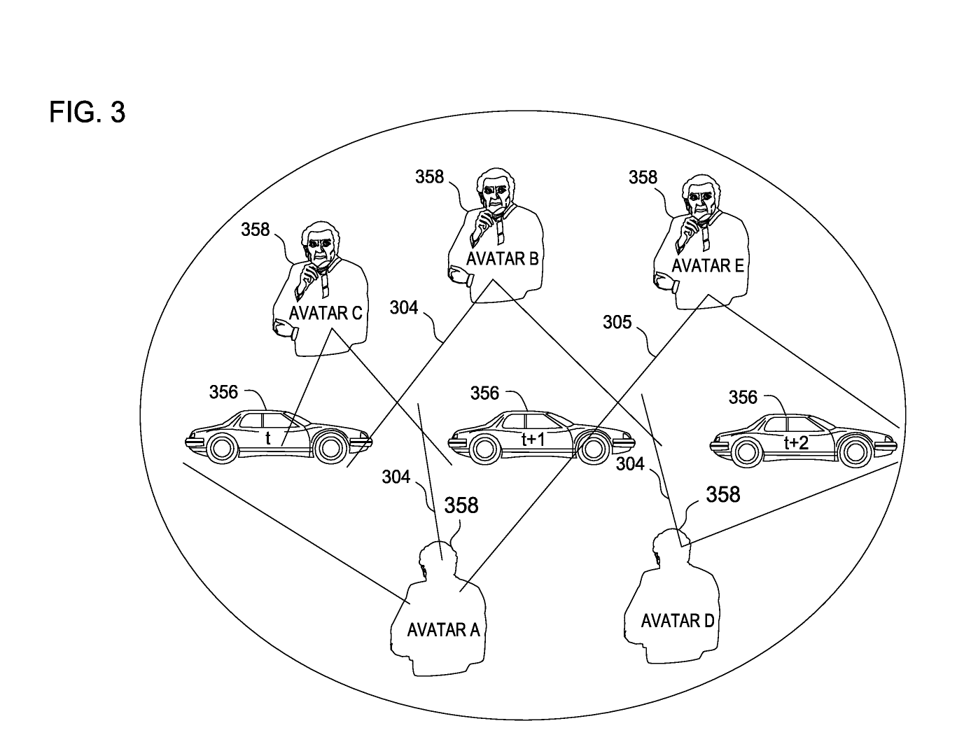

According to one embodiment, the reconstruct application 162 may reconstruct a virtual scene over a specific timeframe requested by the user. Beyond rendering a virtual scene at time-point “t” the reconstruct application 162 may render a virtual scene between a time-point t, and time-point t+n, where the user may view elements 256 and avatars 258 in motion from multiple perspectives. In other words, the virtual scene may be reconstructed with content that is both static as described above, and in motion, as described below in FIG. 3.

FIG. 3 illustrates an example virtual scene 300 with multiple users present over a time interval, according to one embodiment of the invention. Virtual scene 300 includes avatars A-E 358, the respective viewports 304 of avatars A-E, and a car 356, travelling past avatars A-E at time points t, t+1, and t+2.

In some embodiments, the reconstruct application may render the motion of the car 356 driving past avatars A-E 358. In response to a user request to reconstruct scene 300 over timeframe, t, through t+n, the reconstruct application may request cache data from users with avatars A-E for the car 356 at time-points t, t+1, and t+2. In the case where cache data is missing, say for the time-point t+1, in some embodiments, the reconstruct application 162 may fill in the missing data based on the data available from time-points t, and t+2.

For example, as shown, the near side of the car 356 is not in the viewports of any of avatars A-E at time-point t+1. In such a case, there may be no data available for the appearance of the near side of the car 356 at time-point t+1. However, based on the positions of the car 356 at time-points t, and t+2, the reconstruct application 162 may determine the position of the car at time-point t+1. Further, the reconstruct application may render the image of the near side of the car 356 (as it appeared at time-point t) in the position calculated for the time-point t+1.

Supposing a change in the appearance of the near side of the car 356 occurs between time-points t and t+2, the reconstruct application 162 may render a morphed image at time-point t+1, that represents a visual progression from the appearance of the near side of the car 356 at time-point t to the appearance of the near side of the car 356 at time-point t+2.

For example, suppose the near side of the car 356 appears unmarred at time-point t. However, at time-point t+2, the near side of the car 356 has a splattered snowball on the door. In such a case, the reconstruct application 162 may render an image of the near side of the car at time-point t+1 such that a snowball appears about to hit the car door.

According to one embodiment, a user may designate trusted users that may reconstruct the user's experiences even though the trusted user was not present. For example, user A is waiting for user B at a rendezvous in a virtual world. User B is late, and informs user A that the delay was due to being chased by a bear at another location. If user A wants to see user B as user B was chased by the bear, user B may permit user A to reconstruct the scene. In such a case, the reconstruct application 162 would perform the reconstruction based on user B's location coordinates at the specified time-point, instead of user A's coordinates. In some embodiments, a user could limit elements 156 or avatar actions that a trusted user may reconstruct.

In other embodiments, the virtual world 154 may be policed by incorporating the above-described trusted user feature. For example, a virtual police force could include avatars that are trusted by all users of the virtual world as a default. Accordingly, any complaints about objective behavior by avatars 158 in the virtual world could be reconstructed based on the location and time coordinates of the complaining user.

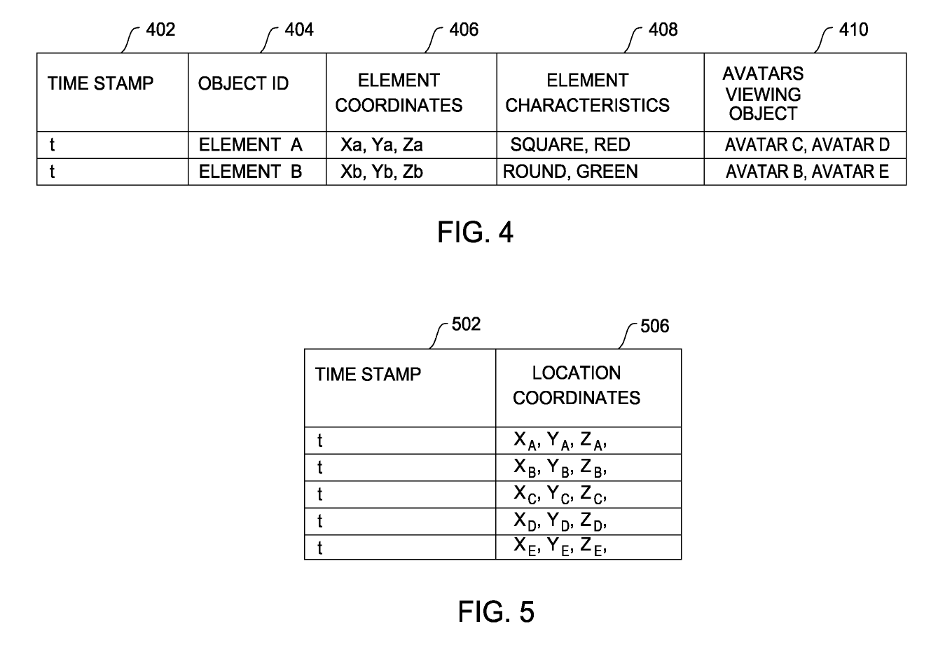

FIG. 4 illustrates an example element table 419, according to one embodiment of the invention. Element table 419 may be one DBMS table in a cache 119. Element table 419 includes a timestamp column 402, element id column 404, element coordinates column 406, element characteristics column 408, and avatars viewing object column 410. The capture application 115 may store one row of data for each element in a user's avatar's viewport, at each time-point. The element id column 404 may contain a distinct identifier for each element 156 encountered during a user's virtual world experience. The element coordinates column 406 may contain geographical coordinates of the element 156 identified in column 404 at the time contained in column 402. The element characteristics column 408 may contain values that describe the element 156 as the element 156 appears to the user at the time stored in column 402. The avatars viewing the object column 410 may contain distinct identifiers of avatars 156 that also contained the element 156 in their respective viewports for the captured time.

For example, the first row of the cache 419 may be captured in the cache 119 of the user for avatar C. The timestamp column 402 contains a ‘t’ value, which merely represents a generic timestamp variable, and is not meant to be representative of actual values stored in embodiments of the invention. Embodiments of the invention may store values of the timestamp column 402 in a standard 16-digit timestamp format for each time-point captured in a user's virtual world experience.

The element id column 404 contains the value “ELEMENT A,” which may uniquely identify the Square element 204 shown in FIG. 2. The coordinate values in column 406 may be stored in a standard Euclidean x, y, z format as shown. Accordingly, at time-point t, the Square 204 was located at coordinates Xa, Ya, Za. It should be noted that the values shown in row one of column 406 are intended to represent distinct variables for the purpose of describing embodiments, and do not represent actual values in embodiments of the invention. The object characteristics column 406 contains the values, “SQUARE,” and “RED,” which may be characteristics of the Square 204, as seen by avatar C. Embodiments of the invention may capture element characteristics in myriad forms, from the simple description here, to a high level of detail that may be captured in any standard image file format such as the joint photographic experts group (JPEG) and moving picture experts group (MPEG) formats. The avatars viewing element column 410 contains the values, “AVATAR C,” and “AVATAR D.” As shown in FIG. 2, both avatars C and D have the Square 204 in their respective viewports 204.

In other embodiments of the invention, the avatars 158 identified in column 410 may only be the avatars in the viewport of the user's avatar for whom the cache 119 is stored. In such a case, the avatars viewing element column 410 may only contain the value, “AVATAR C,” if a particular embodiment treats an avatar 256 as being included in the avatar's own viewport 204. Row two of the cache 419 contains similar values as row one.

Because larger caches 119 may enhance the available detail for reconstructions, in some embodiment, the users may be provided incentives to commit larger amounts of storage space to their individual caches. For example, cash payments (either virtual or real) could be provided to users that capture data that other users request for reconstructions. Another example of an incentive is correlating the number of data requests allowed for a user's reconstruction to the size of the particular user's cache 119.

FIG. 5 illustrates an example avatar location table 519, according to one embodiment of the invention. Avatar location table 519 may be one DBMS table in a cache 119. Avatar location table 519 includes timestamp column 502, and location coordinates column 506. The avatar location table 519 may identify the location coordinates in the location coordinates column 506 for a user's avatar at time-points captured throughout the user's virtual world experience. There may be one row for each time-point captured in the timestamp column 502. Accordingly, as shown in row one of table 519, an avatar such as avatar A, was present at location Xa, Ya, Za at time-point t.

Embodiments of the invention may vary the scale of time at which the data about elements 156 and avatars 158, is cached and accordingly, reconstructed. In one embodiment, the time scale may be uniform for all users. In other embodiments, the time scale may vary between users, according to the size of each user's cache, or due to system performance considerations. In one embodiment, the time scale may measure in a range from portions of seconds to multiple seconds. Particular implementations may limit the range in correlation with performance characteristics of the client computers 102 and/or the virtual world server 142.

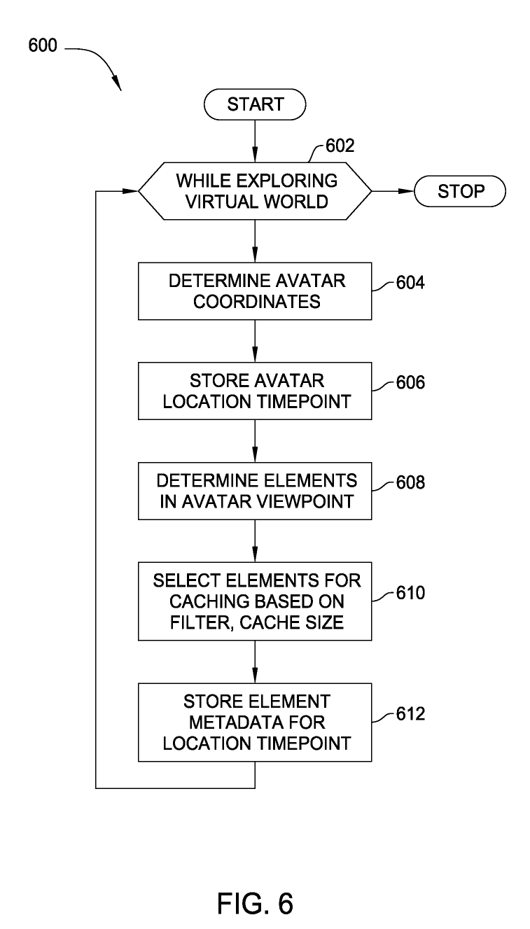

FIG. 6 illustrates a process 600 for caching data in a virtual environment, according to one embodiment of the invention. Process 600 provides a continuous loop that executes while a user interacts with the virtual environment. One execution of the loop resents one time-point that occurred while the user interacted with the virtual world environment. The loop begins at step 602 and includes steps 604-612.

At step 604, the capture application 115 determines a set of location coordinates within the virtual world corresponding to the position of the user's avatar. At step 606 may store the location coordinates for the user's avatar in the cache 519. At step 608, the capture application 115 may determine the elements 156 that are in the user's avatar's viewport. That is, the set of elements then currently visible to the user. At step 610, the filter 117 may select from the visible elements to determine which elements 156 to store in the cache 119. The filter 117 may prioritize all the elements based on factors such as size or movement. In such a case, cache 119 may store elements with the highest priority. The number of elements to be cached may be user-specific or system-specific. At step 612, the capture application 115 may store the selected elements in the cache 119 (e.g., as entries in table 419 illustrated in FIG. 4).

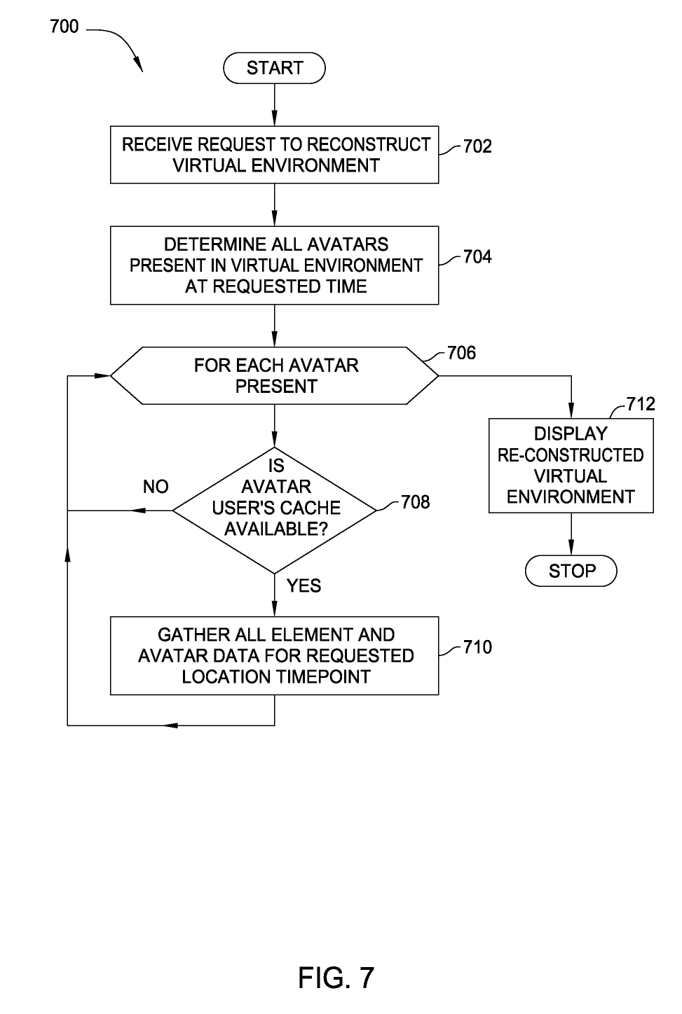

FIG. 7 illustrates a process 700 for reconstructing a virtual scene from multiple viewpoints, according to one embodiment of the invention. As shown, the process 700 begins at step 702, where the reconstruct application 162 receives a request to reconstruct a virtual scene at a particular time point “t.” In some embodiments, the request specifies location and time coordinates (including a time range, if requested by the user).

At step 704, the reconstruct application 162 determines what avatars 156 were present at the virtual scene at the requested time point “t.” The reconstruct application may query the avatar locations 519 in individual user caches. In other embodiments, the reconstruct application 162 may determine the avatars 158 present by the avatars viewing element column values for all the elements in the requesting user's cache 119. In turn, the reconstruct application may recursively query the element data tables 419 for the time and location coordinates until the avatars found are exhausted. In some embodiments, the reconstruct application may only determine the avatars within a limited geographic space at the time specified in the request.

At step 706, a loop begins for each avatar present (as determined at step 704). The loop includes steps 708 and 710. At step 708, the reconstruct application determines whether the avatar's user's cache 119 is available for reconstruction. If not, the loop continues with the next user's avatar. At step 710, if the avatar's user's cache 119 is available, the reconstruct application 162 gathers all element and avatar data for the specified location and time coordinates, from the user's cache 119.

After all element and avatar data is gathered, at step 712, the reconstruct application, renders the appropriate images (static or dynamic, as appropriate) to display the reconstructed virtual scene.

While the foregoing is directed to embodiments of the present invention, other and further embodiments of the invention may be devised without departing from the basic scope thereof, and the scope thereof is determined by the claims that follow.

What is claimed is:

1. A method of capturing scene data from a scene in an interactive virtual environment, comprising:
determining a viewport associated with a first avatar based on a position of the first avatar in the interactive virtual environment at a specified time-point, wherein the viewport includes a set of elements in the scene visible to the first avatar at the specified time-point;
selecting one or more elements from the set of elements of the virtual world visible in the viewport;
determining element location coordinates that specify a position of each selected virtual world element in the interactive virtual environment;
generating, for each selected element, a description that includes at least the element location coordinates for a respective element;
storing the generated descriptions in a first cache; and
associating the first cache with the first avatar, wherein the descriptions of the scene are accessible for reconstructing the scene by a user associated with a second avatar over a peer-to-peer network.

2. The method of claim 1, wherein the one or more elements are selected based on a filter that specifies or more criteria compared to characteristics of each of the set of elements.

3. The method of claim 2, wherein the criteria include at least one of:
a size of a given element;
a rate of movement of a given element; and
a focus specifying whether a given element is in a background or foreground of the scene.

4. The method of claim 1, wherein the description further includes at least one of:
a size of the respective element;
a color of the respective element;
a shape of the respective element; and
a rate of movement of the respective element.

5. The method of claim 4, wherein the description further includes an indication of one or more additional avatars within a specified distance of the first avatar.

6. The method of claim 1, further comprising:
receiving a request to reconstruct the scene from the second user; and
reconstructing the scene for the second user based on the generated descriptions stored in the first cache, and on one or more generated descriptions stored in a second cache associated with the second user.

7. The method of claim 1, wherein the one or more generated descriptions stored in the second cache includes a second description of at least one of the selected elements stored in the first cache.

8. The method of claim 7, wherein at least one of the descriptions stored in the second cache describes an element of the scene not described in the first cache.

9. A computer-readable storage medium containing a program that when executed, performs an operation for capturing scene data from a scene in an interactive virtual environment, comprising:
determining a viewport associated with a first avatar based on a position of the first avatar in the interactive virtual environment at a specified time-point, wherein the viewport includes a set of elements in the scene visible to the first avatar at the specified time-point;
selecting one or more elements from the set of elements of the virtual world visible in the viewport;
determining element location coordinates that specify a position of each selected virtual world element in the interactive virtual environment;
generating, for each selected element, a description that includes at least the element location coordinates for a respective element;
storing the generated descriptions in a first cache; and
associating the first cache with the first avatar, wherein the descriptions of the scene are accessible for reconstructing the scene by a user associated with a second avatar over a peer-to-peer network.

10. The computer-readable storage medium of claim 9, wherein the one or more elements are selected based on a filter that specifies or more criteria compared to characteristics of each of the set of elements.

11. The computer-readable storage medium of claim 10, wherein the criteria include at least one of:
a size of a given element;
a rate of movement of a given element; and
a focus specifying whether a given element is in a background or foreground of the scene.

12. The computer-readable storage medium of claim 9, wherein the description further includes at least one of:
a size of the respective element;
a color of the respective element;
a shape of the respective element; and
a rate of movement of the respective element.

13. The computer-readable storage medium of claim 12, wherein the description further includes an indication of one or more additional avatars within a specified distance of the first avatar.

14. The computer-readable storage medium of claim 9, wherein the operation further comprises:
receiving a request to reconstruct the scene from the second user; and
reconstructing the scene for the second user based on the generated descriptions stored in the first cache, and on one or more generated descriptions stored in a second cache associated with the second user.

15. The computer-readable storage medium of claim 9, wherein the one or more generated descriptions stored in the second cache includes a second description of at least one of the selected elements stored in the first cache.

16. The computer-readable storage medium of claim 15, wherein at least one of the descriptions stored in the second cache describes an element of the scene not described in the first cache.

17. A system, comprising:
a processor; and
a memory containing a containing a program that, when executed by the processor, performs an operation for capturing scene data from a scene in an interactive virtual environment, the operation comprising:
determining a viewport associated with a first avatar based on a position of the first avatar in the interactive virtual environment at a specified time-point, wherein the viewport includes a set of elements in the scene visible to the first avatar at the specified time-point,
selecting one or more elements from the set of elements of the virtual world visible in the viewport,
determining element location coordinates that specify a position of each selected virtual world element in the interactive virtual environment,
generating, for each selected element, a description that includes at least the element location coordinates for a respective element;
storing the generated descriptions in a first cache, and
associating the first cache with the first avatar, wherein the descriptions of the scene are accessible for reconstructing the scene by a user associated with a second avatar over a peer-to-peer network.

18. The system of claim 17, wherein the one or more elements are selected based on a filter that specifies or more criteria compared to characteristics of each of the set of elements.

19. The system of claim 18, wherein the criteria include at least one of:
a size of a given element;
a rate of movement of a given element; and
a focus specifying whether a given element is in a background or foreground of the scene.

20. The system of claim 17, wherein the description further includes at least one of:
a size of the respective element;
a color of the respective element;
a shape of the respective element; and
a rate of movement of the respective element.

21. The system of claim 20, wherein the description further includes an indication of one or more additional avatars within a specified distance of the first avatar.

22. The system of claim 17, wherein the operation further comprises:
receiving a request to reconstruct the scene from the second user; and
reconstructing the scene for the second user based on the generated descriptions stored in the first cache, and on one or more generated descriptions stored in a second cache associated with the second user.

23. The system of claim 17, wherein the one or more generated descriptions stored in the second cache includes a second description of at least one of the selected elements stored in the first cache.

24. The system of claim 23, wherein at least one of the descriptions stored in the second cache describes an element of the scene not described in the first cache.
